(19) United States
(12) Patent Application Publication
(10) Pub. No.: US 2014/0366045 A1
(43) Pub. Date: Dec. 11, 2014

(54) DYNAMIC MANAGEMENT OF COMPOSABLE API SETS

(71) Applicant: Microsoft Corporation, Redmond, WA (US)

(72) Inventors: Steven West, Redmond, WA (US); Philippe Joubert, Kirkland, WA (US); Dragos Sambotin, Sammamish, WA (US); Thomas Getzinger, Bellevue, WA (US); Arun Kishan, Kirkland, WA (US)

(21) Appl. No.: 13/912,523

(22) Filed: Jun. 7, 2013

(51) Int. Cl. G06F 9/54

(52) U.S. Cl. CPC G06F 9/54
USPC 719/328

(57) ABSTRACT

Systems and methods for composing a dynamic runtime API set schema employing a base API set schema and a set of API set schema extensions are disclosed. A base API set schema may be loaded into system memory at boot time with an associated set of host base binaries. A set of API set schema extensions binaries may also be loaded into system memory at boot time. At a second time, the API set schema extensions may be merged into the base API set schema on a dynamic as-needed basis.

### BACKGROUND

Computers may be programmed to perform many types of important functions. Frequently, the programming is implemented as numerous software components that interact to yield a desired behavior for the computer. The software components may be initially stored in some form of non-volatile memory, such as a hard disk. Such memory can provide persistent storage for a large amount of computer software and data used in operating a computer.

However, a conventional computer system traditionally does not execute software components directly from non-volatile memory. The non-volatile memory may be too slow to allow access to instructions and data as the computer operates. Accordingly, a conventional computer may “load” software components before they are executed so that they can use fast memory.

Frequently, some software is loaded each time a computer is powered up. However, not all software is loaded at power up. A computer may be programmed with more software than is used at one time. Accordingly, it is known to dynamically load software components. These components are stored as a file containing computer-executable instructions in a form that can be executed without compiling. These files also may be called “binaries” or “executables.”

Loading is done by a component of an operating system, called a “loader.” The loader performs multiple operations that are needed to make a binary ready for execution, including allocating fast memory to store computer-executable instructions that make up the binary. The loader may also trigger allocation of fast memory to store data accessed by the binary.

A binary may implement multiple functions, sometimes referred to as a library of functions. The functions implemented in a binary may be defined in an “interface contract.” The interface contract defines application programming interfaces (APIs) that can be used to access the functions in the library. Other components may be said to “consume” the interface contract. Once the binary is loaded, the consuming components can access, or link to, all of the functions in the library by accessing the functions using interfaces defined in the interface contract. For this reason, a software component that is loaded in this fashion may be called a “dynamically linked library.”

Because the interface contract for a component is known in advance, components consuming the interface contract can be written using APIs defined by that contract so that they can interact with the library. Each dynamically linked library may include an import address table that identifies other dynamically linked libraries that it consumes, which are sometimes referred to as dependent dynamically linked libraries. When one dynamically linked library is loaded, a loader may load the dependent binaries for that library. Though, a loader may defer loading dependent binaries until a later time, such as when the dependent binaries are actually accessed.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

Systems and methods for composing a dynamic runtime API set schema employing a base API set schema and a set of API set schema extensions are disclosed. A base API set schema may be loaded into system memory at boot time with an associated set of host base binaries. A set of API set schema extensions binaries may also be loaded into system memory at boot time. At a second time, the API set schema extensions may be merged into the base API set schema on a dynamic as-needed basis.

In one embodiment, a method for composing a dynamic runtime API set schema for a set of applications in a computer system is disclosed, comprising: loading a base API set schema into system memory at a first time, said base API set schema further comprising: a set of base API contracts and, for each said base API contract, a set of associated host binaries; merging a set of API set schema extensions into system memory at a second time, said API set schema extensions further comprising: a set of extension API contracts and, for each said extension API contract, a set of associated extension binaries; wherein further said extension API contracts comprise one of a group, said group comprising: base API contracts and new API contracts; wherein further said extension binaries comprise one of a group, said group comprising base binaries and new binaries.

In another embodiment, a system for loading a dynamic runtime API set schema for a set of applications is disclosed, comprising: a controller; a system memory; an operating system; and a loader, said loader capable of loading a base API set schema into system memory at boot time, said base API set schema further comprising a set of base API contracts and for each said base API contract, a set of associated host binaries; and further wherein said loader is capable of merging a set of API set schema extensions into said system memory at a second time, said API set schema extensions further comprising: a set of extension API contracts and, for each said extension API contract, a set of associated extension binaries.

Other features and aspects of the present system are presented below in the Detailed Description when read in connection with the drawings presented within this application.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1A depicts an exemplary environment in which the present system may reside, as made in accordance with the principles of the present application.

FIG. 1B depicts an exemplary loader that may be used in conjunction with the present system.

FIG. 2 depicts the general software architecture of the base API set schema and a set of API set schema extensions that may be merged with the base API set schema dynamically on an as-needed basis.

FIG. 3 depicts a high level flowchart of the operation of one embodiment of the present system.

FIG. 4 depicts a flowchart embodiment of the merge operation of API set schema extensions with the base API set schema extensions on a dynamic basis.

FIGS. 5 through 7 depict one paradigm example of a merged API set schema extension.

FIGS. 8 and 9 depict another paradigm example of a merged API set schema extension.

FIGS. 10 and 11 depict yet another paradigm example of a merged API set schema extension.

### DETAILED DESCRIPTION

As utilized herein, terms “component,” “system,” “interface,” “controller” and the like are intended to refer to a computer-related entity, either hardware, software (e.g., in execution), and/or firmware. For example, any of these terms can be a process running on a processor, a processor, an object, an executable, a program, and/or a computer. By way of illustration, both an application running on a server and the server can be a component and/or controller. One or more components/controllers can reside within a process and a component/controller can be localized on one computer and/or distributed between two or more computers.

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

### GLOSSARY

The following terms are used in the present application and may take the following meaning, depending upon the context:

| Technical Term | Description |
|---|---|
| API Set Contract | An API set contract is an API set name corresponding |
| | to a declared set of API interfaces (functions) exported |
| | by the API set. |
| API Set Host | An API set host is a binary that implements one or |
| | more API set contracts. |
| API Set Schema | An API set schema is a data structure that allows a |
| | mapping to be obtained - at run-time - from an API set |
| | contract to the binary that hosts the implementation of |
| | the contract. |

An API set schemas implemented by a specific product are known at build time, and are typically immutable thereafter. Furthermore, the API sets that are mandatorily implemented and the ones that are “optional” for a product may also be known at build time. A build process may then build a combined “mandatory” base schema, and N smaller extension schemas for the optional components. In addition, an API set may be constructed on a per-partition basis. Each such partition corresponds loosely to a particular SKU of an operating system and might be hard-coded in the build tools. This typically means that if a new SKU is created, the tool-chain may need to be modified at great expense.

Usually, there is no mechanism for optional components to augment the information in the API set schema. Thus, it may be typical to ensure that all schema information for every optional component is present in the schema that built with the operating system. This means that there are a lot of host entries required in the schema for host binaries that are not present. This may lead to runtime inefficiency and it may be required to detect the presence of these binaries through some other route. For example, to determine if a specific extension exists, an application may probe the schema and check whether the host binary exists, rather than simply querying the schema. It may also reduce the flexibility of existing SKUs to adapt to the presence of optional components.

Without the ability to automatically detect which hosts are present in a particular SKU may mean that modifying the SKU (e.g., by adding or removing an API set host binary) and ensuring that the schema remains consistent may tend to be error prone. This may represent an investment in time to ensure that the schema contents accurately reflect the contents of the SKU image.

### INTRODUCTION

It may be desirable to affect a flexible scheme for implementing an API set. Such a flexible scheme might comprise techniques for dynamic and extensible API set builds—e.g., one that may allow changes after an initial build and one that may be independent of partitions.

In one embodiment, a composable API set schema is disclosed that may allow extensions to the schema to be installed, read in at boot time and added to the base schema created during the build. Such an embodiment might allow optional components to install (e.g., in the field) additional schema information for contracts that are only hosted in binaries that are installed with that optional component.

In one embodiment of a composable API set schema, a base schema may be constructed by determining which host binaries are present in the SKU, and a schema generated accordingly. This may tend to simplify the creation of a new schema. In such an embodiment, the concept of a partition may no longer be relevant.

It may be desirable for some embodiments to define a “base API set schema” and allow “API set schema extensions” to be installed into an image to be read in during boot and to be used to augment the base API set schema dynamically and as-needed. Such API set extension may further comprise additional API set contracts, as well as additional API set hosts.

In one further embodiment, it may be desirable to use SKU image contents to construct the base API set schema.

General Environment

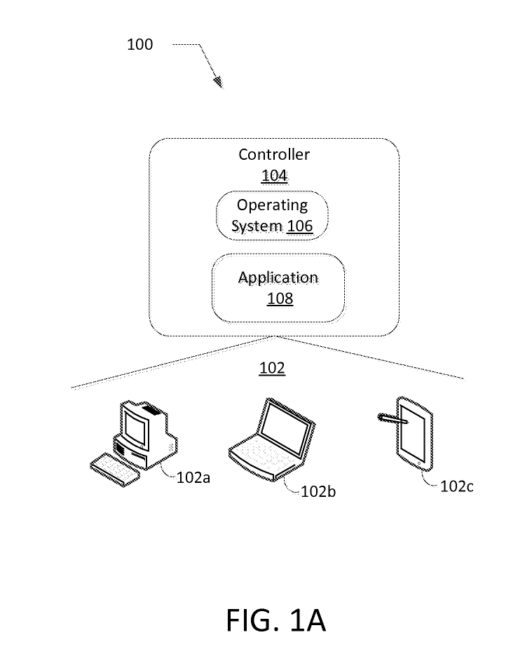

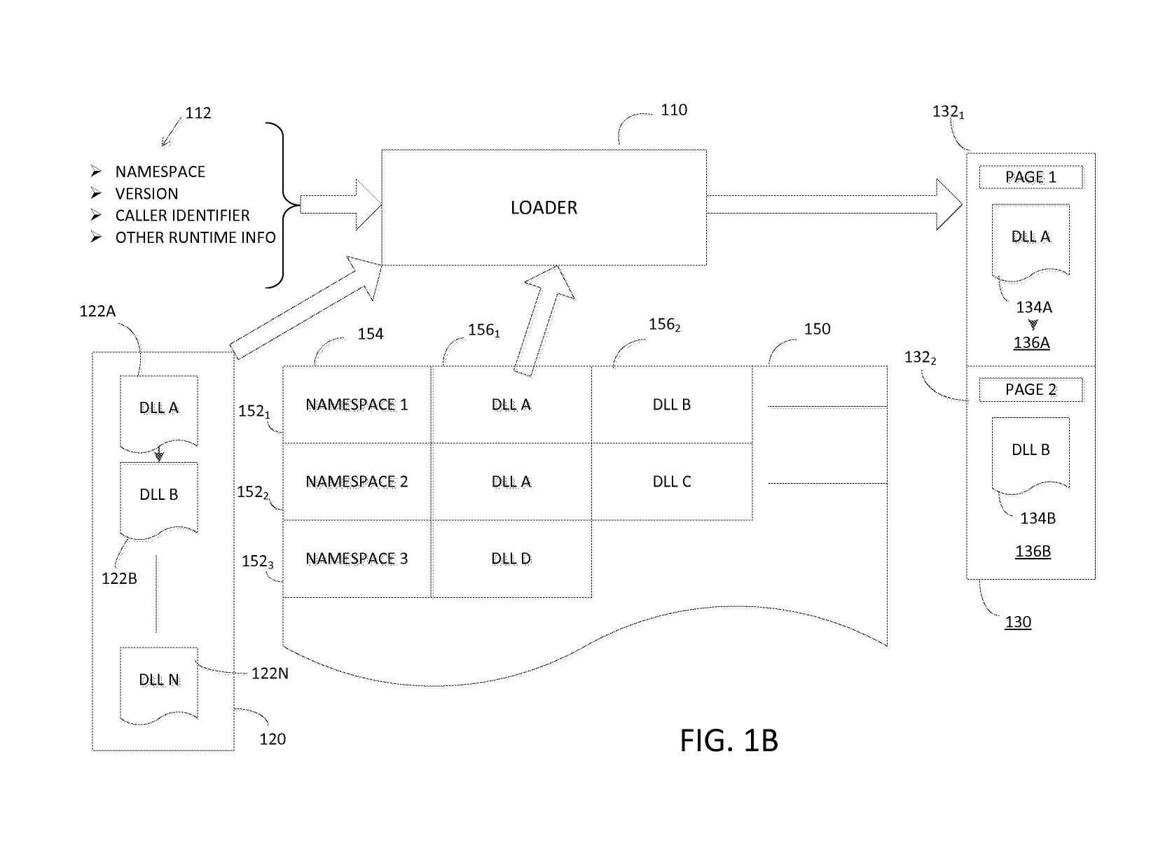

In the embodiment illustrated in FIG. 1A, a suitable computer system 100 is depicted. Computer system 100 may comprise a number of embodiments—e.g. PC/desktops 102a, laptop 102b, tablet/smart device/smart phone 102c, as mere examples for such suitable computer systems 102. Computer system 102 may further comprise a controller 104 (further comprise one or more processors), an operating system 106 and at least one application 108 which may be actuated by a user or the computer system itself.

Both application 108 and operating system 106 may contain multiple components. As is known in the art, these components may comprise dynamically linked libraries, binaries or executables. Also, as is known in the art, when application 108 is launched in computer system 102, one or more of the dynamically linked libraries making up application 108 may be loaded for execution.

A dynamically linked library may comprise multiple portions containing different types of information needed for computer system 102 to execute functions encoded in the dynamically linked library. Each dynamically linked library may comprise a code portion and a dependency portion. The code portion of each of the dynamically linked libraries may comprise computer-executable instructions that may be executed by one or more processors/controllers of computer system 102. The dependency portion of each dynamically linked library may identify other dynamically linked libraries on which the dynamically linked library may depend for proper operation.

In computer system 102, the dependency portion of dynamically linked libraries within application 120 may be implemented as an import address table identifying dependent dynamically linked libraries by name. However, in accordance with embodiments of the present application, some or all of the dependency information may be specified by identifying an API namespace against which the code in the associated code portion was developed. The dependency portion, for example, may identify one or more API namespaces that define interfaces to functions called from within code in the code portion.

In operation, the dependency information may signify to a loader that dependent dynamically linked libraries should also be loaded to support execution of a dynamically linked library. For example, dependency information may indicate that a dynamically linked library depends, for operation, —e.g., on a namespace A. That namespace may be implemented by one, or more, dynamically linked libraries within operating system, which are loaded when a dynamically linked library is loaded such that instructions within code portion may access functions implemented by the namespace.

To support such accessing of functions provided by a dynamically linked library, each dynamically linked library may implement an “interface contract.” The interface contract contains information defining the interfaces through which consuming components may access functions performed by that dynamically linked library. For example, an interface contract may be reflected in a header file associated with the dependent dynamically linked library in a development environment. Through a process of compiling the dynamically linked library and loading it, the information in the header file may be translated into programming interfaces upon which other components may place calls when the dynamically linked library is loaded for execution.

A dynamically linked library may indicate that it consumes a particular namespace (say Namespace A). Namespace A may be mapped to a dependent dynamically linked library within the operating system. In addition, dynamically linked libraries may consume more than one API namespace.

FIG. 1B shows a software architecture for one configuration of a computer system, with one possible mapping between namespaces and components. FIG. 1B illustrates portions of a computer system that may resolve an API namespace to a set of dependent binaries, which are then loaded. In this example, these functions are performed by a loader within an operating system. Such a loader may be constructed using techniques as are known in the art. However, rather than operate based on an indication that a dependent dynamically linked library is to be loaded, as is conventional, loader 110 alternatively or additionally operates on an indication that an API namespace is to be loaded.

Accordingly, loader 110 receives as input parameters 112 that provide an indication that an API namespace is to be loaded. Such an indication may be generated in any suitable way, such as a part of initializing a computer system, in response to an indication that an application should be launched or in response to operations performed within a component that is already loaded and executing.

Parameters 112 may be any suitable parameters and may be in any suitable format. In the example of FIG. 1B, parameters 112 include an identifier for the API namespace to be loaded. The parameters 112 may include an identifier for the version of the API namespace against which a component triggering loading of the API namespace was coded. For example, dependency portions, in addition to identifying the API namespace, may identify a version assigned to a specific set of dependent dynamically linked libraries that implemented that API namespace at the time the respective dynamically linked libraries 122a . . . 122n were coded.

As the dependent dynamically linked libraries are changed, the version identifier may change. A numbering scheme may be adopted for the version identifier to differentiate between major and minor changes. However, any suitable mechanism may be used to identify versions of the set of components that implement an API namespace.

Any other suitable parameters may be provided as inputs to loader 110. The parameters, for example, may include an identifier of the caller. In this case, the caller refers to a component that depends on the API namespace and has triggered the loading of the API namespace. In the example of FIG. 1B, dynamically linked library 122a is the caller for the API namespace A when namespace A is loaded to support calls from functions made from within dynamically linked library 122a.

Other types of information may also be provided as input parameters for loader 110. This information could include, for example, a hardware configuration, a software configuration or any other suitable runtime information.

Loader 110 may use the input parameters 112 to access a map to identify a set of components that collectively implement the functions contained within the API namespace identified in parameters 112. Here a map 150 is illustrated. Map 150 may be implemented as a data structure stored in memory within a computer system. In the example of FIG. 1B, map 150 is implemented as a data structure with multiple rows, of which three rows, 152₁, 152₂ and 152₃ are shown. Each of the rows maps a namespace to a set of components that collectively implement a namespace associated with the row. In the example of FIG. 1B, three rows are shown for simplicity, but any number of rows may be included in map 150.

In the example of FIG. 1B, map 150 contains multiple columns, of which columns 154, 156₁ and 156₂ are shown. Each column includes information of a specific type used by loader 110 to resolve a namespace to a set of components. Column 154 contains an identifier of a namespace. In operation, loader 110 matches a namespace identified in input parameters 112 to a row in map 150 based on the values in column 154.

The remaining columns, here illustrated as columns 156₁ and 156₂ contain identifiers for components that implement the namespace identified in each row. Here, two columns, 156₁ and 156₂, are shown for simplicity. However, any suitable number of columns may be included in map 150, allowing any suitable number of components to be associated with a namespace through map 150.

Map 150 may be created in any suitable way. In this example, map 150 provides information relating to namespaces supported by a framework, such as an operating system. Accordingly, the information in map 150 could be collected at the time a configuration of an operating system is developed. A tool, for example, may scan the code base for the operating system, collecting references to namespaces and identifying the components that implement functions identified in the interface contract for each namespace. Though other approaches for obtaining this information may also be used. For example, implementation of a namespaces may be declarative, meaning that a component may declare that it implements a particular namespace contract.

Regardless of how created, the map may then be supplied to computer users in conjunction with the operating system, such that users receiving different configuration of the operating system will receive a map with different information, mapping the same API namespaces to different sets of components. Alternatively or additionally, map 150 may be supplied to a computer user as part of a patch that updates an operating system. As an example of another possible variation, the map may be built or altered dynamically, with vendors that supply software that either consumes specific namespaces or supports additional or alternative namespaces, providing an executable component or other mechanism that modifies or extends the map.

It should be appreciated that the rows and columns of map 150 are a schematic representation of organization of information, indicating graphically related information that may be used to relate components to a namespace. Any suitable organization of information may be used. For example, map 150 may be stored as a schema in any suitable format, such as in an XML file or a database.

Regardless of how map 150 is created or stored, in operation, loader 110 identifies based on the input parameters 112 and map 150 components to implement a namespace to be resolved under the current runtime conditions. Once loader 110 identifies the components associated with a namespace to be resolved, loader 110 may load those components using techniques as are known in the art. However, any suitable technique for loading executable components may be used.

In the example of FIG. 1B, the computer system includes nonvolatile memory 120 in which multiple dynamically linked libraries 122A, 122B . . . 122N are stored. Each of the dynamically linked libraries may be stored as a separate file or with any other suitable organization.

Regardless of how the components are stored, when loader 110 resolves a namespace identified in parameters 112 to a set of components, it obtains those components from nonvolatile memory 120. Loader 110 then creates memory structures in fast memory 130 and otherwise triggers action that makes the components ready for execution. Fast memory 130, for example, may be RAM or other suitable memory within a computer system. Any suitable memory structures may be created for each component to be loaded. The memory structures created in fast memory 130 may be memory structures as are known in the art. In this example, loader 110 creates a space in fast memory 130 for each component to be loaded that contains one or more pages. In this example, pages 132₁ and 132₂ are shown, each containing information associated with one loaded component.

The information stored in each page may be information as is known in the art. As an example, the information in page 132₁ may include executable code 134A associated with a component to implement some portion of the functions in the namespace. Page 132₂ may include executable code 134B, which may implement a second portion of the functions in the namespace. Though not expressly illustrated, the pages associated with each of the loaded components may contain different or additional types of information. For example, memory structures storing variables accessed by the components as they execute and other information may similarly be stored in the pages allocated for each loaded component.

FIG. 1B illustrates a way in which inefficiencies may be avoided using a map as described above. In the simple example of FIG. 1B, each loaded component is allocated one page of memory. Any number of pages may be allocated for any component. However, in the embodiment illustrated, a page is the smallest unit of memory that may be allocated for a component. Each component is unlikely to require an amount of memory that is an even multiple of a page. Accordingly, the memory allocated for each component is likely to contain unused memory. FIG. 1B shows unused memory 136A in page 132₁ and unused memory 136B in page 132₂.

It should be recognized and appreciated that mapping an API namespace to components as illustrated in FIG. 1B reduces the total amount of unused memory allocated to components that are loaded while still providing flexibility. As a specific example, flexibility could be achieved by having every function within operating system interface set 152 implemented in a separate component. However, as illustrated in FIG. 1B, for every component loaded, there may be unused memory, such as unused memory 136A and 136B. By increasing the number of components that need to be loaded to implement an API namespace, the total amount of memory increases. However, as has been described above, incorporating a mapping capability into an operating system allows flexibility in the manner in which API namespaces are implemented with less unused memory wasted. The mapping capability may also improve performance of the framework over time by reducing the time spent on disk access in successive versions of the framework. In one case, the API set may decouple the API namespace from the implementation, which allows multiple API sets to live in the same binary, or move between binaries release to release with little to no compatibility impact to applications. As experience allows identification of the most commonly used namespaces, the components of the framework can be reorganized to include the components implementing those namespaces in the same or a small number of components. However, the mapping capability avoids the need to change applications or other components interacting with the framework.

Composable API Set Schema Embodiments

The API set schemas may comprise a data structure that is used to resolve API set contract references to the host binary that implements the contract. In one embodiment, this may be implemented as a single data structure embedded in a PE binary file—e.g., named apisetschema.dll. This binary may be loaded at boot time by the loader. The loader may use the schema to resolve any API set dependencies from boot-load binaries. In this manner, kernel-mode extensions may be resolved. The loader makes the loaded image of the API set schema binary available to the memory manager. The memory manager may use this to resolve any future kernel-mode API set dependencies. In addition, this may also causes the API set data to be mapped into every process that is started on the system. In one embodiment, this may be used by the user-mode loader (in ntdll.dll) to resolve any user-mode API set dependencies.

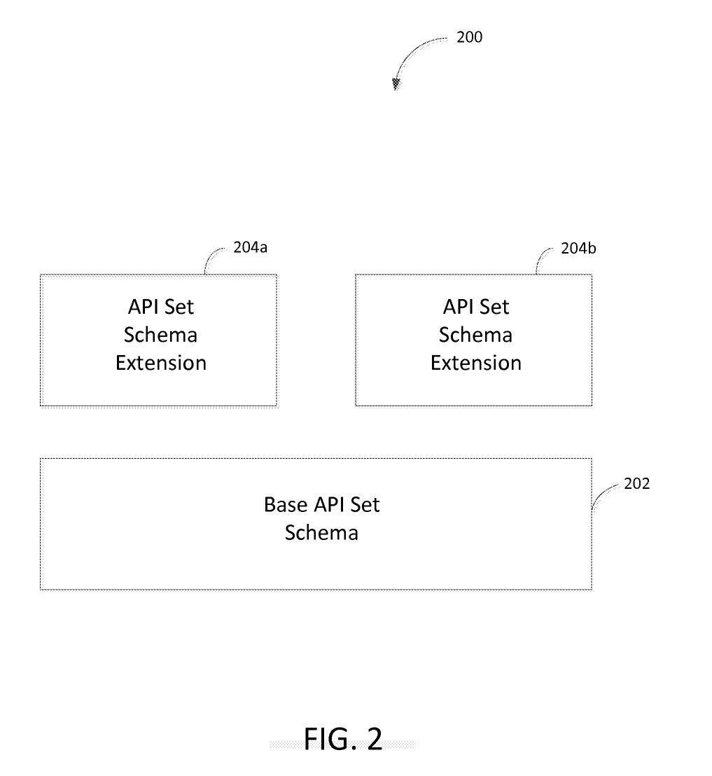

FIG. 2 depicts one embodiment of a composable API set schema 200 as made in accordance with the principles of the present application. In this embodiment, API set schema 200 may comprise two parts:

(1) The base API set schema (202); and

(2) API Set Schema Extension(s) (e.g., 204a and/or 204b).

Base API set schema 202 may comprise all base API set contracts and host binaries that may not be uninstalled from the OS image. This may map to elements of the schema that are installed during post-build, and are in packages that may not be later uninstalled. Each base API set contract may comprise a set of associated base binaries that may be loaded into system memory at a given first time—e.g., at boot time.

API set schema extensions represent additional contracts and host binaries that are installed via optional components. They may be encapsulated in Portable Executable images and may be registered with the OS. They may then be loaded by the loader at the same time as the loading of the base schema. The loader may merge the data from the schema extensions into the base schema to generate a superset of the base schema. This new schema composition is the one that may be used to resolve API set dependencies (e.g., in the loader, kernel-mode or user-mode).

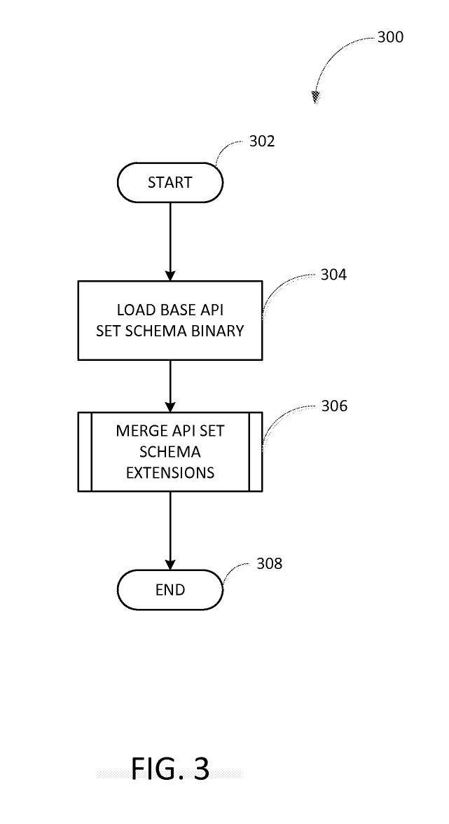

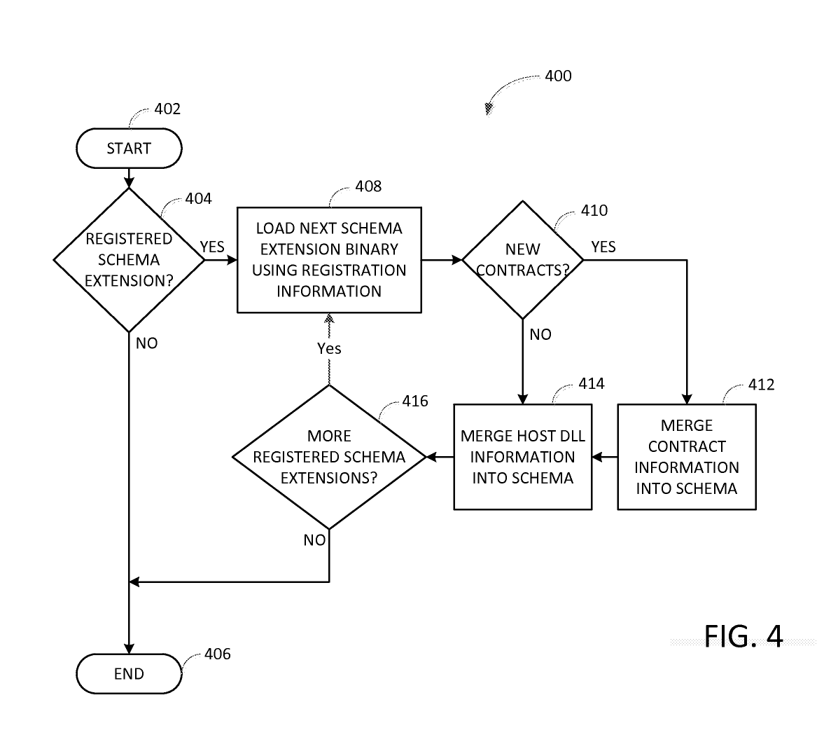

FIGS. 3 and 4 depict high level flowcharts of modules that are suitable for the loading and merging of the various components described above. FIG. 3 is one embodiment of an API Set Schema Composition module 300. Starting at 300, composition module 300 may start to load the Base API Set Schema binary at 304. At 306, the module may merge the API Set Schema Extensions and end the process at 308. It will be appreciated that this module may reside in the loader as discussed above—or elsewhere, as appropriate in the computer system.

FIG. 4 is one embodiment of a Merge API Set Schema Extension module 400. At 402, this module may start. At 404, the present system may query whether there is a schema extensions currently registered. If not, the module may end at 406—or be placed in a continuous test of 404.

If so, then the present system may load the next schema extension binary using registration information at 408. The present system may then query as to whether there are new contracts at 410. If so, then the present system may merge the contract information into the schema at 412.

If not (or after 412), the present system may merge the host DLL information into the schema at 414. The present system may then ask whether there are any more schema extensions registered at 416. If so, then the present system will continue processing at 408. Otherwise, the present system may end (or continuous wait/test) at 406.

Specifying API Set Contracts

In one embodiment, API set contracts may be indicated by using the TARGETNAME and API_SET_CONTRACT_GEN macros. The API set contract XML files may be generated during the Build Dev step of timebuild.

The “product” that the API set contract appears in is derived from a macro in the build environment that can be one of the following (which are offered merely as non-limiting examples for the purpose of illustration):

| MACRO VALUE | PRODUCT |
|---|---|
| BUILD_MOBILECORE = 1 | Mobilecore |
| BUILD_CLIENTCORE = 1 | Clientcore |
| BUILD_MINCORE = 1 | Mincore |
| BUILD_MINWIN = 1 | Minwin |
| Otherwise | OS |

The “product” may become embedded in the contract XML document, but may not be used in the final API set schema data. It may cause the XML documents to be placed in folders named “contracts” under subfolders corresponding to the particular product.

This logic may be contained in a file. In some embodiments, the BUILD_xxxx macro may be omitted, since all contracts known during the build will be present in the base schema.

Specifying API Set Hosts

A new macro may be added to the sources file to indicate that the binary being built is a host for an API set contract. The macro name may be API_SET_HOST, and the value may be a white-space separated list of API set contract aliases referring to the latest API set version. The alias may be specified as a fully-qualified name as well.

The API set host XML files may be generated during the Build Dev step of timebuild. In one embodiment, the XML document for the hosts may contain the “product” that the host appears in. In one case, the XML files are just a tool to aggregate the data needed to construct the API set schema (e.g., what are all the contracts, and who implements them, for this specific product of interest).

Constructing the Base API Set Schema

Since the schema differentiation will closely mimic the SKU differentiation, it may be desirable to implement this as a tag in the manifest that includes the API set contract or host binary. When the images are assembled, it may be possible to generate the list of contracts and hosts that have been installed in the image. The base API set schema and schema extensions can then be built and installed accordingly.

In one embodiment, it may be possible to install the schema in the image as part of the image assembly (e.g., presumably as part of a manifest assembly), but the process that constructs the schema may have to be able to determine which contracts and hosts are present in the image.

In another embodiment, it may be possible to build the image twice—once, to determine which contracts and hosts are present in the image, and a second time, after the base schema has been built and signed, and can be included in the image correctly.

In yet another embodiment, it may be possible and desirable to use configuration files for specifying the contracts and hosts that may be included the base schemas for each SKU. The schema may be constructed early using the configuration file, and then once the image is assembled, the configuration would be checked against the contents of the SKU. It may be possible to check for any deviations and update the configuration and restart the postbuild phase of the build, as desired.

In one embodiment, a new flag field may be introduced into the API set schema structure. This flag may indicate whether a schema is sealed. If the “sealed” bit is set, then no extensions will be considered. This may be used in a full-OS SKUs to prevent extensions from being loaded.

In addition, it may also be desirable to introduce a flag field for contracts in the base schema indicating that said contract is sealed. If said flag is set to a desired value, then that contract may not be modified via a schema extension. In this embodiment, the pre-contract flag field may prevent a particular contract from being overridden. If both flag fields are included in an embodiment, then the present system may have a per-contract and a per-schema technique to prevent overrides.

It may be possible to modify legacy schema-generating modules to accept this new configuration file—instead of the old, partition based configuration file. For security purposes, it would be desirable to have the API set schema signed with a signing certificate to prevent the schema from being used as an attack vector. It should be noted that if the schema fails to load at boot time due to it being incorrectly signed, then the boot would fail.

Constructing the API Set Schema Extensions

In one embodiment, since the base schema may comprise every contract known at the time of it being built, there may be no need for schema extensions to contain new contracts. A single schema extension may comprise a list of host binaries, and for each host binary, a list of API set contracts that the binary hosts. In some embodiments, the mechanism for constructing schema extensions may allow only one host binary to be specified.

The API set extension may comprise the following:
1. The host binary name;
2. The contracts implemented by this host. These may be specified interchangeably using the full name or the alias. If an alias is used, then all contracts with a matching alias may be considered hosted by the binary in question; and/or
3. Any contracts that are overridden by this host. An override is a special mechanism that allows API set resolution to be different, depending on which binary is attempting to resolve it.

The API set extension binary may be differentiated from a base API set schema using a flags field in the schema structure. Only a schema extension that is marked correctly as a host extension will be considered by the loader.

Installing the Base API Set Schema

The base API set schema, once constructed, may be installed into the OS image using a manifest assembly. The name may be unchanged—e.g., apisetschema.dll. The binary may be signed with a signing certificate to be loaded. This may be desirable to prevent it from being replaced with another schema that may allow undesired operation or redirect the OS to execute malicious code.

Installing API Set Schema Extensions

In one embodiment, API set schema extensions may also be installed using manifest assemblies. These manifest assemblies may also comprise the registry data in order to register the schema. This may appear in the registry—e.g., in the following format:

HKEY_LOCAL_MACHINE\SYSTEM\CurrentControlSet\Control\
Session Manager\APISetSchema\<ID>
REG_SZ Data = “filename”

The ID may be a UUID—unique to the particular schema extension being registered. The format of the filename of the schema extension may yet to be determined, but it may (e.g., as a convention) contain the same ID that is used for registration.

For security reasons, these schema extension binaries may be signed with a signing certificate, for example the same one as the base schema binary.

It should be noted that optional component packages may be capable of carrying schema extensions. If such packages are installed online, then a reboot should be performed.

Loading the API Set Schema

The base API set schema may be loaded in the same way as in a legacy schema, but the data may be copied into an internal data structure in the loader. This may allow for the expansion of the schema when the extensions are loaded.

The loader may then enumerate all of the schema extensions from the registry, and load each one. Each new host that is detected may be inserted into the schema, and the corresponding contract (if found) may be modified to point to the correct host binary. Any overrides may also be inserted at this time. If the contract is not found, this may be construed as an error and the system may fail to boot.

Once the API set schema is loaded (i.e., base schema and schema extensions), the resolution of API set dependencies should proceed in exactly the same way as with legacy systems. The file images may then be unloaded to release the memory that they occupy.

Resolving API Set Dependencies

Once the API set is composed at boot time, the resolution of API set dependencies may be handled by the same API set helper library as with legacy systems. The helper library may be linked into the loader, the kernel memory manager and NTDLL.

Exemplary Processing Embodiments

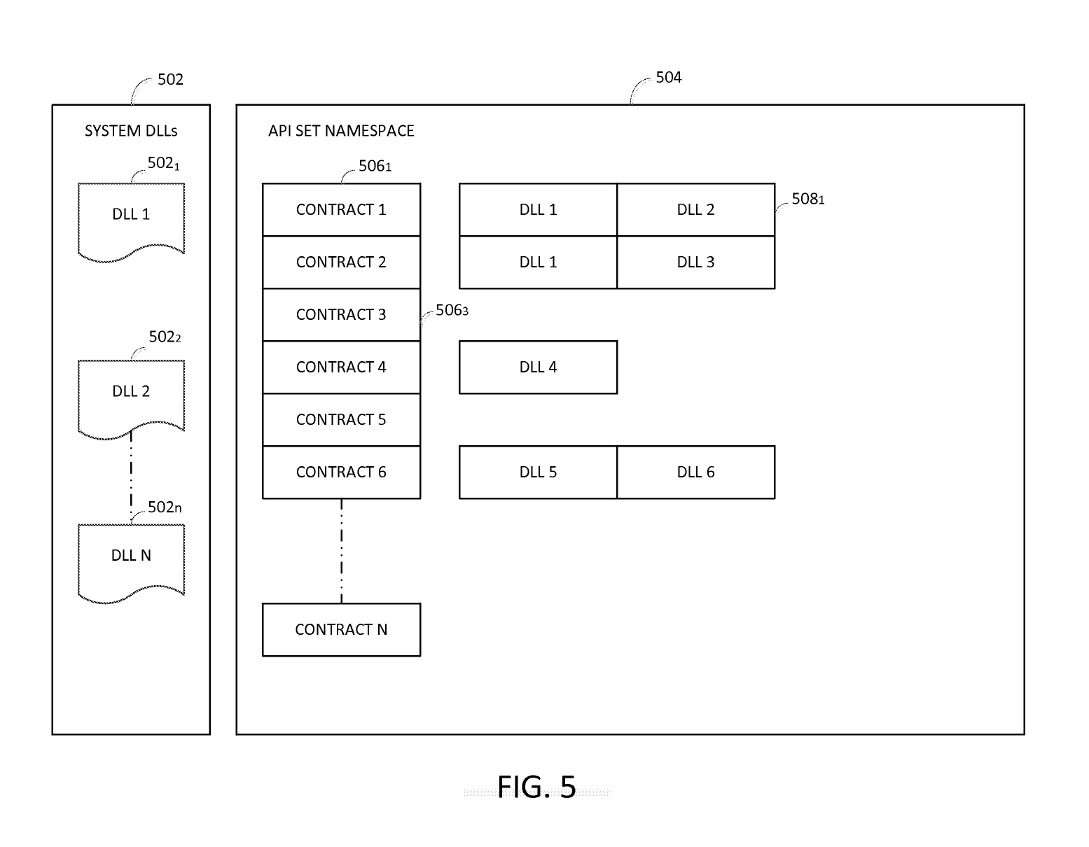

Referring now to FIGS. 5 through 11, there will now be described some processing embodiments. It should be appreciated that these embodiments are merely for expository purposes and are not meant to narrow the scope of the present application.

FIGS. 5 through 7 depict one progressive exemplary taking place over time. In a first time, FIG. 5 depicts an initial state of the system—with a set of system DLLs 502 (with existing DLL1 (502₁), DLL2 (502₂) and up through DLLn (502ₙ)), an API Set Namespace 504 residing in system memory. As may be seen, API Set Namespace comprises a number of contracts (e.g., Contract1 (506₁) and Contract3 (506₃)—along with other contracts).

Each contract may be seen as having an associated set of DLLs that have been loaded into system memory, as desired. So, as may be seen, Contract1 has DLL1 and DLL2 as an associated set 508₁. It may also be seen that Contract 3 has a null set of associated DLLs.

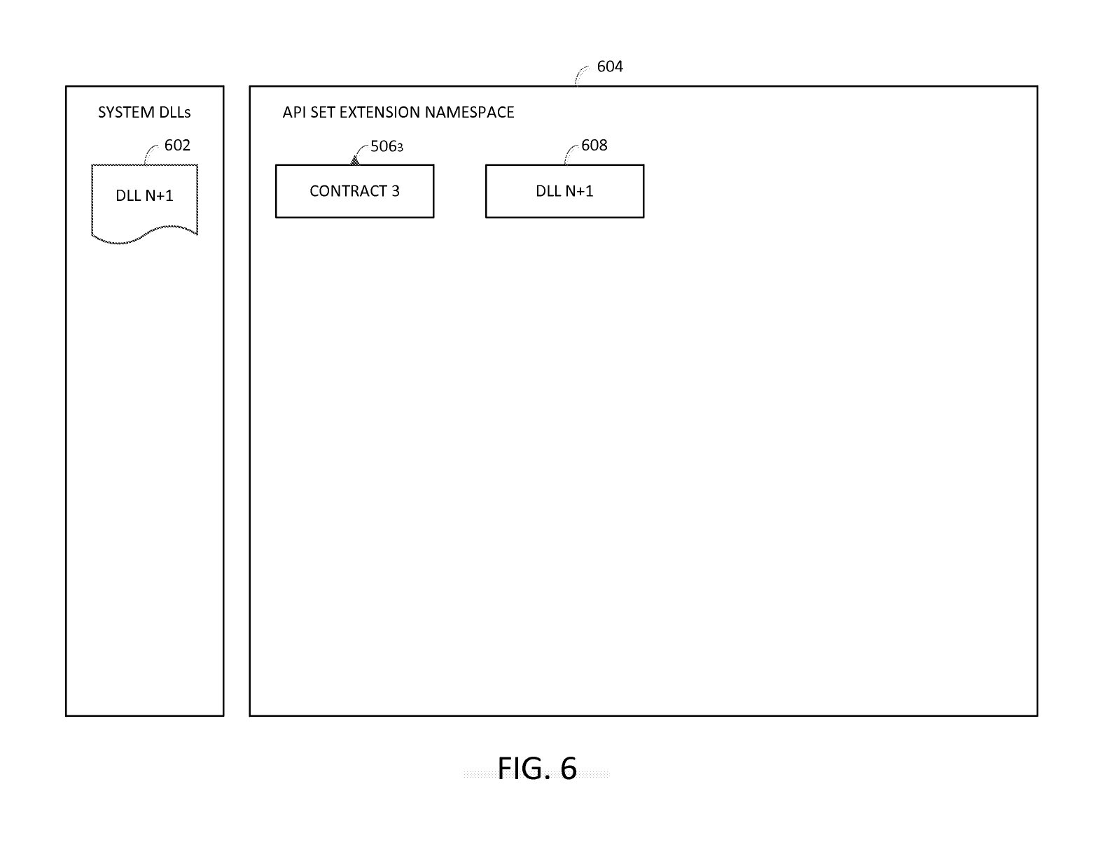

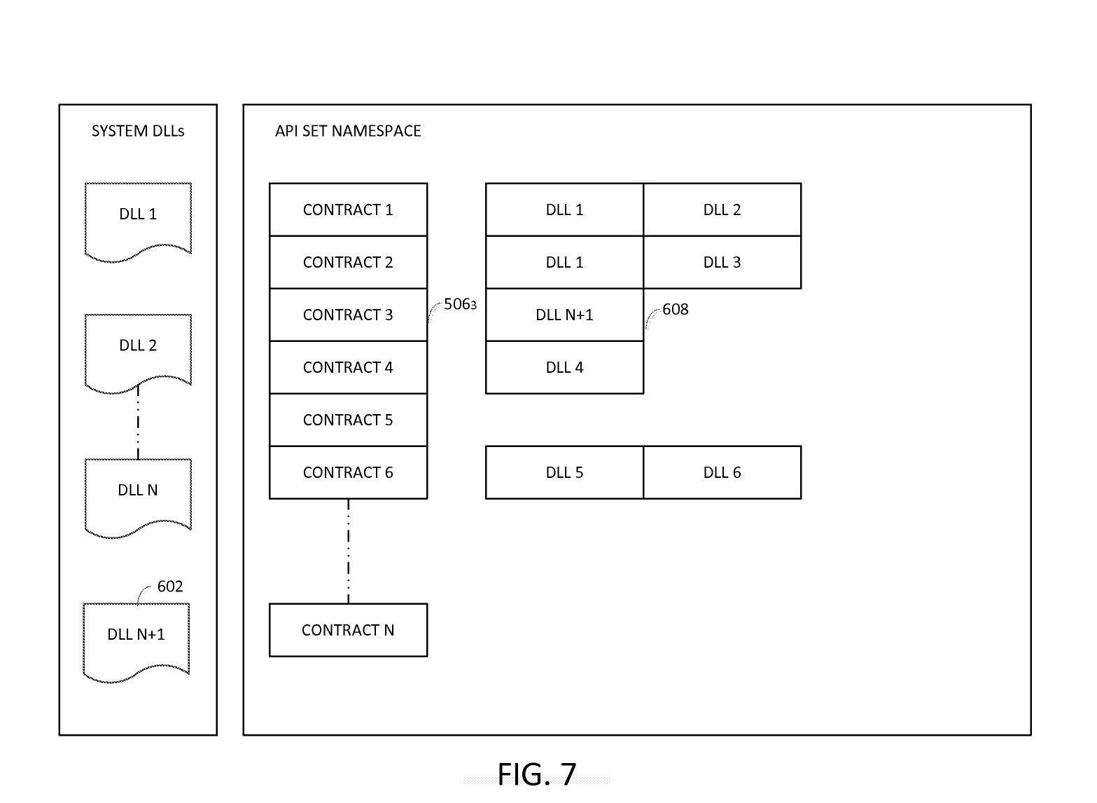

At a future time, as shown in FIG. 6, Contract 3 (506₃) may have a new DLL N+1 (602) associated with it in in the API Set Extension Namespace 604—e.g., as DLL N+1 (608). In FIG. 7, the loader dynamically may then load the DLL N+1 into the existing API Set Namespace.

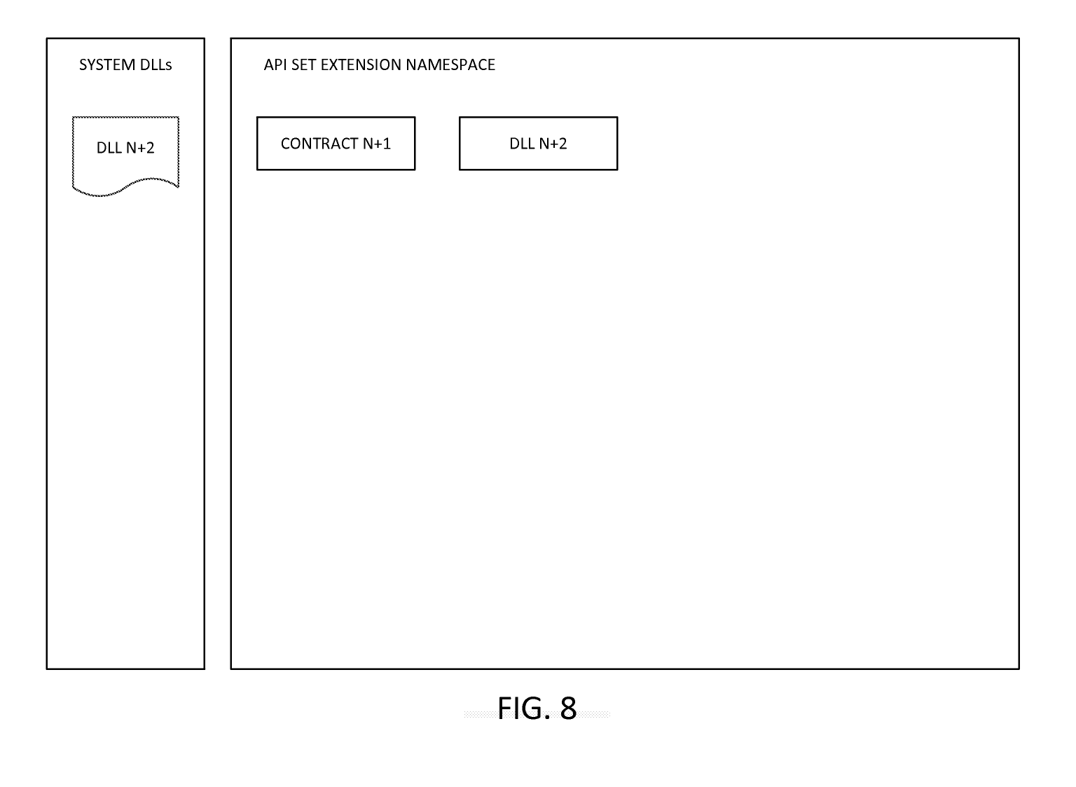

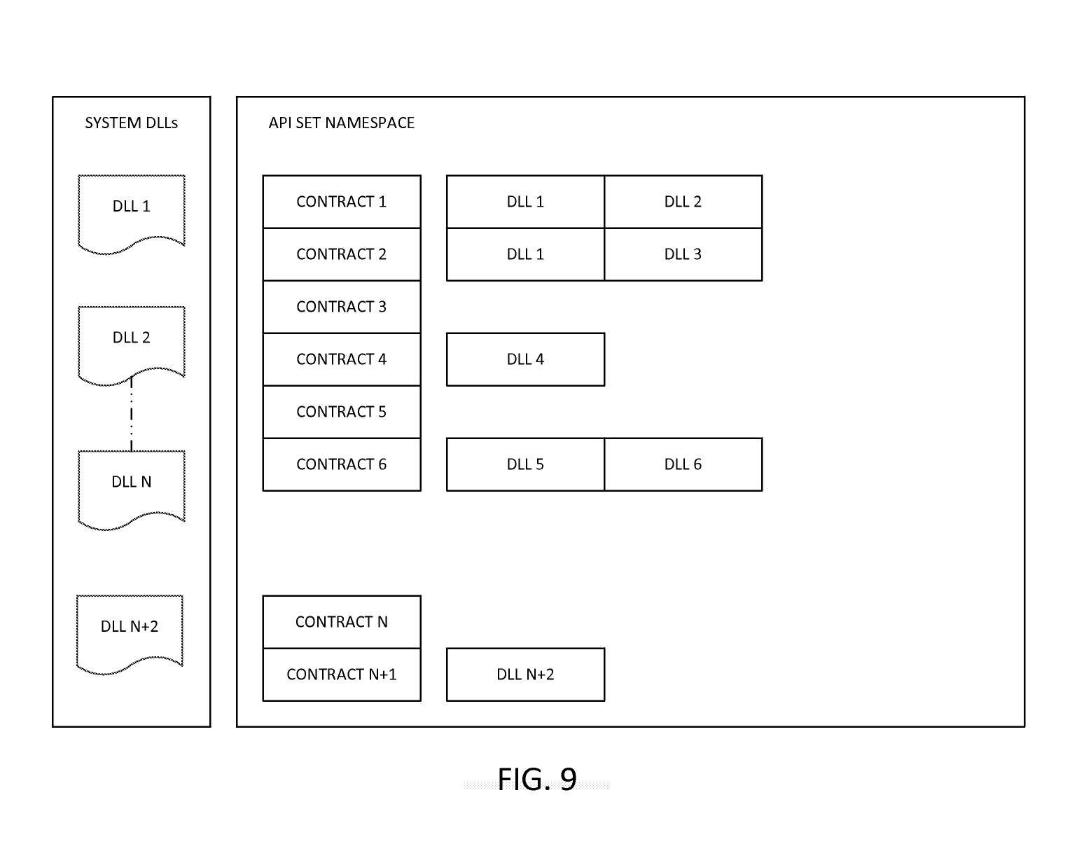

FIGS. 8 and 9 depict how the present system may load a new Contract N+1 dynamically with a new associated DLL N+2. FIG. 8 show these new components in their respective memory—e.g., Contract N+1 in the API Set Extension Namespace and DLL N+2 in both the System DLL and the API Set Extension Namespace. In FIG. 9, the present system may then load Contract N+1 and DLL N+2 into the API Set Namespace dynamically, as desired.

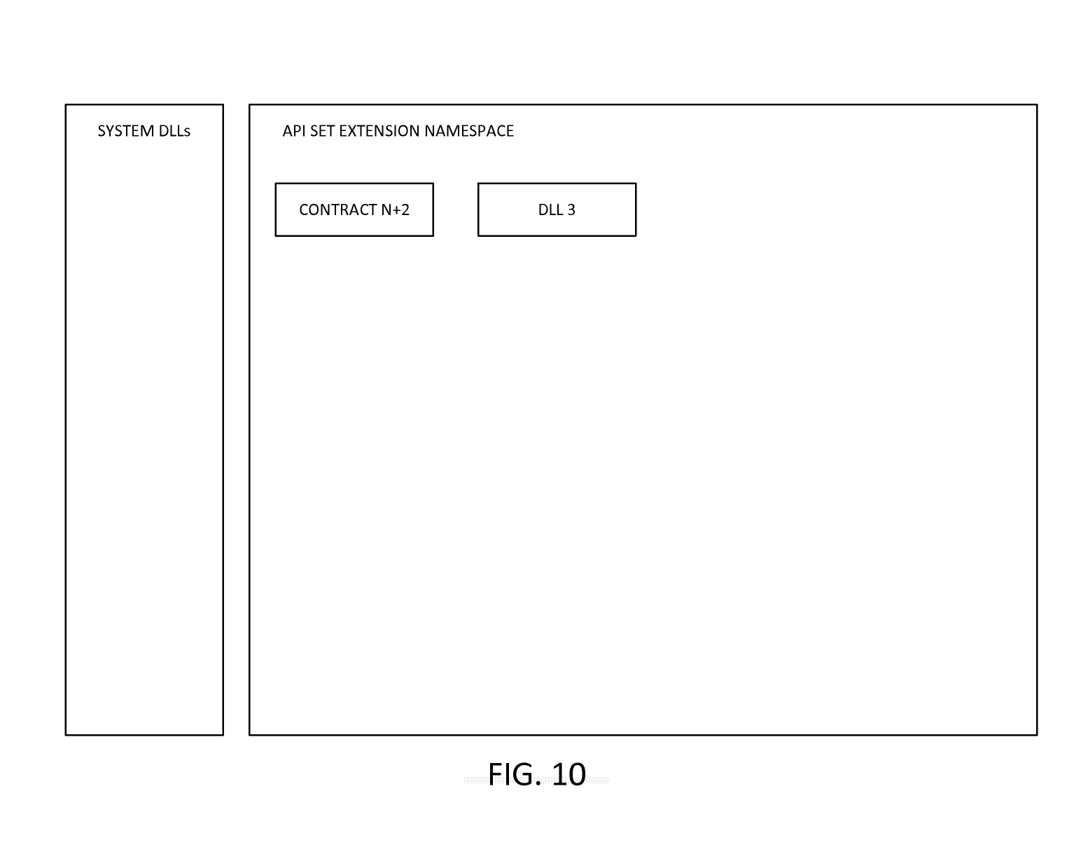

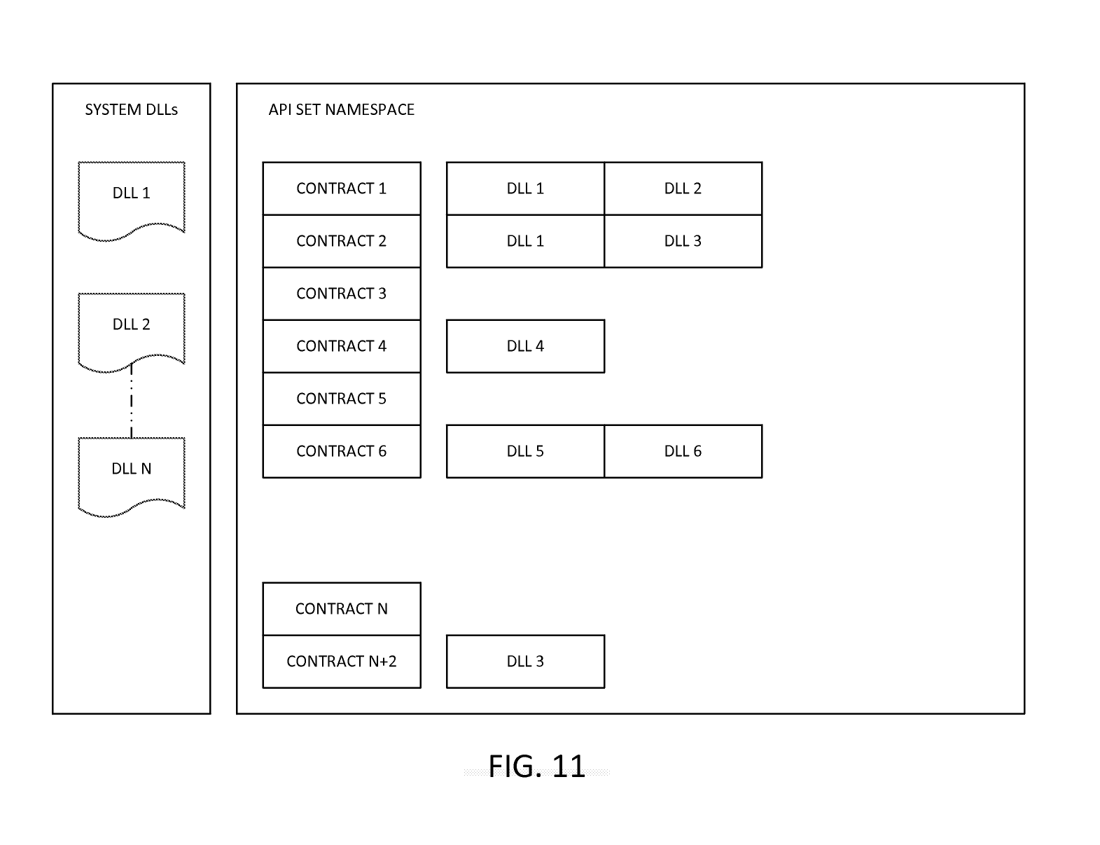

FIGS. 10 and 11 depict how the present system may load a new Contract N+2 dynamically with an existing associated DLL 3. FIG. 10 shows these components in their respective memory—e.g., Contract N+2 in the API Set Extension Namespace and DLL 3 in the API Set Extension Namespace. In FIG. 11, the present system may then load Contract N+1 and another copy of DLL 3 into the API Set Namespace dynamically, as desired.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

1. A method for composing a dynamic runtime API set schema for a set of applications in a computer system, said computer system comprising a controller, a system memory and an operating system, the method comprising:
loading a base API set schema into system memory at a first time, said base API set schema further comprising: a set of base API contracts and, for each said base API contract, a set of associated host binaries;
merging a set of API set schema extensions into system memory at a second time, said API set schema extensions further comprising: a set of extension API contracts and, for each said extension API contract, a set of associated extension binaries;
wherein further said extension API contracts comprise one of a group, said group comprising: base API contracts and new API contracts;
wherein further said extension binaries comprise one of a group, said group comprising base binaries and new binaries.

2. The method of claim 1 wherein said loading a base API set schema into system memory at a first time further comprises:
loading a base API set schema into system memory at boot time.

3. The method of claim 2 wherein the method further comprises:
loading a set of API set schema extensions into system memory at boot time.

4. The method of claim 3 wherein merging a set of API set schema extensions into system memory at a second time further comprises:
for any registered API set schema extensions:
loading said API set schema extension binaries;
for any new extension API contracts:
merging said new extension API contract information into the API set schema;
merging extension DLLs into the API set schema.

5. The method of claim 4 wherein merging a set of API set schema extensions into system memory further comprises:
merging said API set schema extensions with said base API set schema dynamically on as as-needed basis.

6. The method of claim 5 wherein said a flag field is provided for one of a group, said group comprising: an API set schema and a contract;
wherein if said flag field is for an API set schema, then no extensions to said schema is allowed; and
wherein if said flag field is for a contract, then no modification to said contract is allowed.

7. The method of claim 6 wherein said API set schema extension further comprises:
a host binary name;
a set of contracts implemented by said host binary name; and
a set of contracts that are overridden by said host binary name.

8. The method of claim 7 wherein the binary of said API set schema extension is differentiated from the base API set schema, said API set schema extension further comprising said flag field and said flag field comprises differentiation data.

9. The method of claim 1 wherein said method further comprises:
installing said base API set schema into the OS image; and
signing the base binaries with a signing certificate.

10. The method of claim 9 wherein said method further comprises:
installing said API set schema extension into the OS image; and
signing the schema extension binaries with a signing certificate.

11. The method of claim 10 wherein said method further comprises:
loading said base API set schema by copying schema data into an internal data structure in the loader.

12. The method of claim 11 wherein said method further comprises:
enumerating all API set schema extensions from the registry; and
loading each API set schema extension into system memory.

13. The method of claim 12 wherein said method further comprises:
resolving the API set dependencies with an API set helper library.

14. The method of claim 11 wherein resolving the API set dependencies further comprises:
linking said API set helper library into the loader, the kernel memory manager and the NTDLL.

15. A system for loading a dynamic runtime API set schema for a set of applications, said system comprising:
a controller;
a system memory;
an operating system; and
a loader, said loader capable of loading a base API set schema into system memory at boot time, said base API set schema further comprising a set of base API contracts and for each said base API contract, a set of associated host binaries; and
further wherein said loader is capable of merging a set of API set schema extensions into said system memory at a second time, said API set schema extensions further comprising: a set of extension API contracts and, for each said extension API contract, a set of associated extension binaries.

16. The system of claim 15 wherein said loader is further capable of merging a set of API set schema extensions into system memory at a second time further comprises:
for any registered API set schema extensions:
loading said API set schema extension binaries;
for any new extension API contracts:
merging said new extension API contract information into the API set schema;
merging extension DLLs into the API set schema.

17. The system of claim 16 wherein said loader is further capable of merging said API set schema extensions with said base API set schema dynamically on as as-needed basis.

18. A computer-readable storage media storing instructions that when executed by a computing device, said instructions cause the computing device to perform operations comprising:
loading a base API set schema into system memory at a first time, said base API set schema further comprising: a set of base API contracts and, for each said base API contract, a set of associated host binaries;
merging a set of API set schema extensions into system memory at a second time, said API set schema extensions further comprising: a set of extension API contracts and, for each said extension API contract, a set of associated extension binaries;
wherein further said extension API contracts comprise one of a group, said group comprising: base API contracts and new API contracts;
wherein further said extension binaries comprise one of a group, said group comprising base binaries and new binaries.

19. The computer-readable storage medium of claim 18 wherein said loading a base API set schema into system memory at a first time further comprises:
loading a base API set schema into system memory at boot time.

20. The computer-readable storage medium of claim 19 wherein said merging a set of API set schema extensions into system memory at a second time further comprises:
for any registered API set schema extensions:
loading said API set schema extension binaries;
for any new extension API contracts:
merging said new extension API contract information into the API set schema;
merging extension DLLs into the API set schema.
